(19) United States
(12) Patent Application Publication
(10) Pub. No.: US 2005/0178410 A1
(43) Pub. Date: Aug. 18, 2005

(54) Low pressure saturated steam cleaning assembly with chemical delivery system

(76) Inventor: Moise Maurice Levy, Pittsfield, MA (US)

Correspondence Address: Scott M. Oldham;Suite 300, One GOJO Plaza, Akron, OH, 44311-1076, US

(21) Appl. No.: 11/055,388

(22) Filed: Feb. 10, 2005

Related U.S. Application Data
(60) Provisional application No. 60/544,668, filed on Feb. 13, 2004.

(51) Int. Cl. B08B 3/02

(52) U.S. Cl. 134/94.1; 134/172; 134/107; 134/102.1; 134/102.2

(57) ABSTRACT

The present invention provides a steam cleaning system comprising a housing and a steam generating system for producing a low pressure, superheated saturated steam. A steam dispensing system comprising a water reservoir and a pump feeding the water into a steam producing boiler, is coupled thereto for dispensing the steam from the system to at least one first outlet port. A cleaning solution dispensing system is provided, having at least one reservoir for a cleaning solution, and a pump system for dispensing a predetermined amount of a cleaning solution from said at least one reservoir to at least one second outlet port. The at least one first and second outlet ports are positioned adjacent one another, such that a mixture of cleaning solution and saturated steam at a low pressure and low volume of steam and cleaning solution is dispensed from the system. The present invention is particularly suited to clean objects off the floor, vertical surfaces such as glass, and small areas of floor. Because of the small volume of water and chemicals used, it can be used indoors, as well as mounted on mobile platforms such as trucks, buggies, utility vehicles, automatic floor scrubbers or the like. The system also provides for cleaning of roads, sidewalks, exterior structures, or for spot cleaning or cleaning of surfaces in difficult environments. The low pressure, superheated, saturated steam cleaning assembly of the present invention provides low pressure (10 Bar) operation, and relies upon superheated steam temperatures coupled with environmentally friendly chemicals as an abrasive force, thus avoiding any collateral damage usually caused by the high pressure output. The present invention only applies 3 to 10 gallons of water an hour, depending on the size of the machine, while a conventional high-pressure washer/steamer will use 240 gallons per hour.

### TECHNICAL FIELD

The present invention relates to cleaning equipment designed to clean and/or disinfect, and more particularly relates to a low-pressure saturated steam cleaning assembly employing environmentally friendly chemicals. More particularly, the invention relates to a low pressure saturated steam cleaning assembly which utilizes a low pressure steam generator providing steam at high temperatures, coupled with environmentally friendly chemicals as an abrasive force, and using small amounts of water and chemical solution to avoid runoff in the cleaning process. The system may also include a vacuum assembly, to selectively dry washed surfaces if desired, and a number of specialized tools for the cleaning of various surfaces.

### BACKGROUND OF THE INVENTION

Cleaning systems come in a variety of configurations depending on the environment. For example, for exterior surfaces, pressure washers that typically use in excess of 240 gallons of water per hour may be used. They may propel either cold or hot water at high pressures of around 150-200 Bars. They are usually employed to clean but not to disinfect surfaces and objects. Due to their excessive water consumption, these commercial pressure washers are not practical to apply at remote locations where water sources are not readily available. Further, if chemicals are used at remote locations, the whole effluent must be removed to insure compliance with environmental regulations. Moreover, the high-pressure spray not only results in excessive run-off, but also causes collateral damage, particularly evident on concrete and stone (limestone, sandstone, etc.).

Other known systems include high pressure steam machines, that also use an excess of water on par with high-pressure washers, and are equally damaging due to their high-pressure output. These machines can clean and assist in disinfecting objects and surfaces since they produce steam at high temperatures up to about 250° F. However, this technology is highly inefficient since an abundance of energy is required to heat up 3 or 4 gallons of water per minute to 212° F. to 250° F. Both electricity and Liquid Petroleum Gas (LPG) are commonly used as concurrent sources of energy. Moreover, runoff cannot be avoided as well.

Although other systems, including low pressure steam machines have been attempted, these machines, while providing some disinfecting ability, often lack abrasive force due to their low-pressure output. Further, machines intended for domestic use, generally lack the ability to continuously feed water into the boiler; this means, as the boiler capacity is quite small, that the user cannot operate the machine for more than a few minutes, and then must wait until the boiler has sufficiently cooled, before replenishing the boiler with water.

The steam cleaners that have been developed use either single phase or three phase current. Briefly, single-phase current is 110 V (3 points plug), while 3-phase is current 220 V (4 or 5 points plug). The former is for domestic or commercial applications, as they do not require a constant flow of steam. The latter is for industrial applications requiring a continuous supply of steam. In Europe and Australia single phase is 220 V and 3-phase 400 V or 440 V. For example, the machine 50 may be provided as a 4 kW, single phase (110V or 220V), or a 4 kW, 8 kW, 16 kW, 32 kW or even 60 kW 3-phase (220V or 420V) machine, depending on the environment and application. With respect to such systems, the single phase equipment may be suitable for ad hoc cleaning tasks which do not require constant steam. Examples of the applications include removal of a few pieces of gum from a carpet or sparse de-weeding on a well-maintained golf course. More generally, single-phase machines are useful for applications in the domestic sector.

Because of the increased power capabilities of 3-phase equipment over single-phase equipment, the 3-phase approach is generally more efficient. For example, an almost a ten-fold increase in productivity have been observed.

Known steam machines that are available are very expensive, and are problematic in several ways. The conventional boiler design heats the water through direct contact with heating element contained within the boiler itself. The direct contact of the heating elements with the water in the boiler significantly reduces reliability, as the eventual caking of the elements with lime causes malfunction of the electronics that control the automatic water feed into the boiler. Additionally, although some machines can deliver cleaning chemicals, they are equipped with very poor quality chemical pumps, which deliver a high volume of chemical solution, and are incapable of handling more powerful solvents, such as environmentally friendly solvents like d-limonene. Such solvents would significantly damage and degrade the seals, hoses and other components of the chemical pump. Consequently, permanent machine damage can result, and a copious effluent consisting of water, chemicals and grease is often generated, which is clearly undesirable. It would also be desirable to provide a highly effective cleaning solution in a manner to mix the cleaning solution with high temperature steam to effectively clean difficult surfaces, or environments.

In addition, in known systems, the machine tooling is also of poor quality and design, often leaking between the tool joints that are only separated by washers. For example, the steam hose is generally made of thin Teflon, and is not sturdy. Control of steam output is also important, and the known systems generally include a control handle that is complicated and is electronically controlled. In practice, this means that both hose and handle have to be attended to on practically a daily basis by a technician to maintain efficient machine operation.

It would be desirable to provide a low pressure steam cleaning and disinfecting system which alleviates the problems noted, to provide an easy to use, effective cleaning/disinfecting system, which can be used in difficult environments and in mobile configurations.

### SUMMARY OF THE INVENTION

The present invention overcomes the disadvantages of the prior art and provides a steam cleaning system comprising a housing and a steam generating system for producing a low pressure saturated steam. A steam dispensing system comprising a water reservoir and a pump feeding the water into a steam producing boiler, is coupled thereto for dispensing the steam from the system to at least one first outlet port. A cleaning solution dispensing system is provided, having at least one reservoir for a cleaning solution, and a pump system for dispensing a predetermined amount of a cleaning solution from said at least one reservoir to at least one second outlet port. The at least one first and second outlet ports are positioned adjacent one another, such that a mixture of cleaning solution and saturated steam at a low pressure and low volume of steam and cleaning solution is dispensed from the system. The present invention is particularly suited to clean objects off the floor, vertical surfaces such as glass, and small areas of floor. Because of the small volume of water and chemicals used, it can be used indoors, as well as mounted on mobile platforms such as trucks, buggies, utility vehicles, automatic floor scrubbers, litter pickers or the like. The system also provides for the cleaning of roads, sidewalks, exterior structures, or for spot cleaning or cleaning of surfaces in difficult environments. The low pressure saturated steam cleaning assembly of the present invention provides low pressure (10 Bar) operation, and relies upon superheated steam temperatures coupled with environmentally friendly chemicals as an abrasive force, thus avoiding any collateral damage usually caused by the high pressure output. The present invention only applies 3 to 10 gallons of water an hour, depending on the size of the machine (which is in turn determined by the size of the boiler), while a conventional high-pressure washer/steamer will use 240 gallons per hour.

### BRIEF DESCRIPTION OF THE DRAWINGS

FIG. 1 is a perspective view of an embodiment of the invention for use in spot-cleaning types of applications.

FIG. 2 is a schematic view of the low pressure steam cleaning system according to an embodiment of the invention.

FIGS. 3a and 3b show cross sections of the handle barrel associated with the system of FIG. 1.

FIG. 4 shows a cross sectional view of the connection of the delivery assembly and a handle portion of the system.

FIG. 5 shows a partial side view of the handle and delivery assembly according to this embodiment.

FIG. 6 shows a partial side view of the handle and delivery assembly according to an alternate embodiment.

FIG. 7 shows a partial side view of an alternative delivery system usable with the system.

FIGS. 8a and 8b show partial top and bottom views of an alternative delivery system usable with the system.

FIGS. 9a-9c show views of alternative brush configurations for use with the delivery system.

FIGS. 10a and 10b show views of alternate squeegee configurations for use with the delivery system.

FIG. 11 shows a cleaning system according to the invention integrated into a mobile platform, such as a sweeper/scrubber.

### DETAILED DESCRIPTION OF THE INVENTION

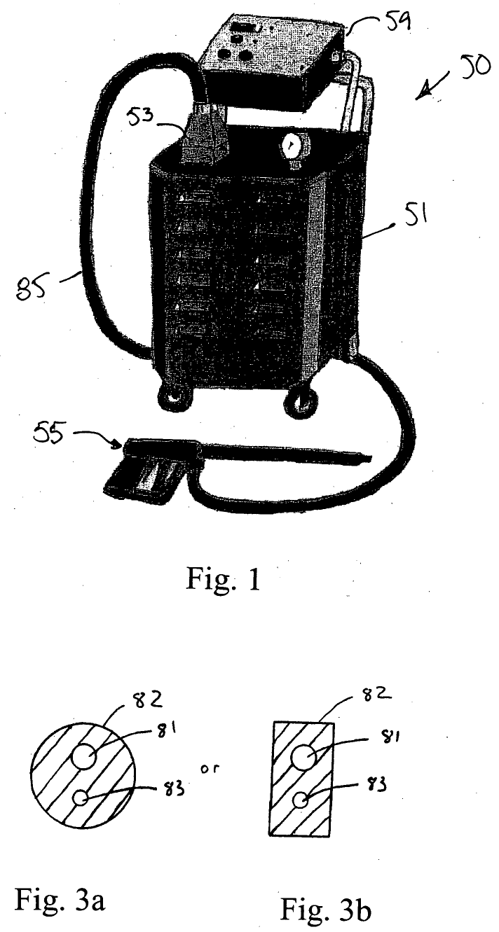

Turning now to the Figs., embodiments of the present invention are shown. The system 50 as shown in FIG. 1 is designed to avoid the problems of the prior art, and provide an effective, efficient cleaning/disinfecting system. In such systems, without the use of generally toxic and non-environmentally friendly chemicals and runoff, which is generally illegal, it is extremely difficult to perform a number of necessary cleaning tasks, such as street cleaning as an example. This is especially true for cleaning surfaces having chewing gum, graffiti or the like. It is thus desirable to provide cleaning services using effective, environmentally friendly chemicals while eliminating runoff. Additionally, the cleaning process and apparatus of the invention allows for effective use in indoor environments, such as residences or factories. In such environments, the low volumes of water and/or chemicals allow use without the need for systems to handle and remove runoff, and the low pressure operation allows use of specialized tools other than nozzles.

The cleaning process and apparatus of the present invention, therefore, uses very little water. The system 50 produces a superheated, but low pressure saturated steam, as well as providing abrasive power for effective cleaning by means of chemical application. The low pressure saturated steam generated by the system 50 may be superheated to about 180° Centigrade or 350° Fahrenheit, at a pressure in the range of about 8-15 Bar (atmosphere), and more preferably about 10 Bar. High-pressure steam machines, on the other hand, output steam in the range of about 150-200 Bar, which is obviously both dangerous and damaging.

The system 50 may also selectively utilize powerful, but environmentally friendly, chemicals to provide the equivalent abrasive power at low pressure as that of a high-pressure steam cleaning device. The superheated steam and the chemicals are mixed with upon dispensing also activate the chemicals for more effective cleaning power. One such suitable solvent, through experimentation, is d-limonene, a solvent degreaser derived from citrus rinds. D-limonene, combined with high temperature saturated steam removes not only grease (and oil spills) but also chewing gum and graffiti. Most chemical solvents used to remove graffiti, by comparison, are carcinogenic. The water-soluble version of d-limonene is preferred over the oil version of the chemical, which does not mix with water. Other more aggressive, environmentally friendly solvents may be used as well depending on the application. Alternatively, for food processing environments as an example, no chemicals may be dispensed, such that the hot steam disinfects without the pathogen immunization problems associated with chemical sanitizers.

The system 50 provides a significant increase in performance, reliability and enables use of the aforementioned more aggressive solvents for the reasons discussed above. Further, since the low pressure saturated steam cleaning assembly of the present invention uses very little water or chemical, the need for a large water or chemical solution reservoirs is not necessary. Unlike pressure washers or high-pressure steam cleaning assemblies, the present invention is extremely suitable for portable and/or remote use.

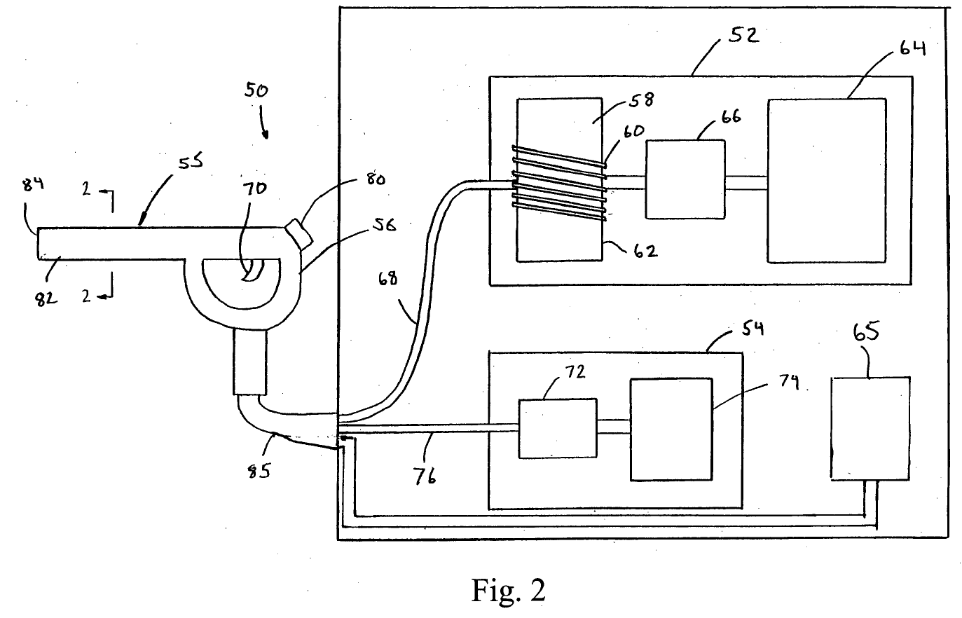

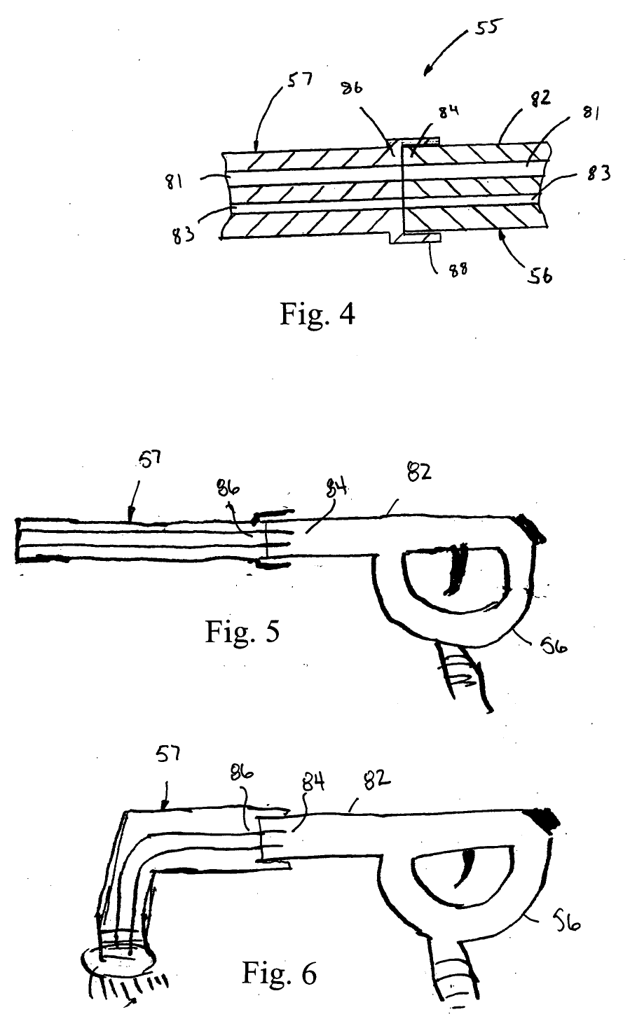

In FIG. 1, the system 50 is provided as a portable housing 51 having output ports 53 to which is selectively coupled a delivery assembly 55 via a hose 85. A control panel 59 provides an operator interface for control of the machine 50, and monitoring operational parameters. As should be evident, the system 50 could be provided in many different configurations, or integrated into other equipment or vehicles, as will hereafter be described in more detail. Schematically, as shown in FIGS. 2 and 4, the low pressure saturated steam cleaning assembly 50 of the present invention includes a steam channel portion 52 and a chemical channel portion 54, both of which are fluidly coupled to a delivery assembly 55 composed of the handle 56 and delivery tools 57 for selective delivery of the chemical solvent and low pressure saturated steam at tool's end exit. The system 50 includes an induction-type boiler device 58. In an induction-type boiler, the heating element 60 does not come in contact with the water as compared to a conventional boiler. Rather, the heating element 60 is provided by heating coils which are wound around the body 62 of the boiler. Moreover, an induction-type boiler is more reliable, and hence insures very low maintenance. One suitable induction-type boiler is that made by ACA Engineering (Australia) for larger units and those of Inoxtecnica (Italy) for smaller (4 kW) units.

Briefly, the steam channel portion 52 of the low pressure saturated steam cleaning assembly 50 of the present invention includes: a water tank 64, a water pump 66 and the induction boiler 58, together with an electronic control system and gauges. The heating coils 60 are wound about the body of the boiler 58, as mentioned. Steam exits through the hose 68 when the handle's trigger 70 of the delivery assembly 55 is depressed.

For some cleaning applications, particularly indoor/interior applications, it may be desirable to provide for effective drying of the cleaned surfaces, even though runoff is minimal. A vacuum system 65 may be selectively used to apply a vacuum to the area being cleaned and effectively dry the area of any residual moisture. The vacuum system may be coupled to the delivery system via a conduit, to apply a slight vacuum at the location of steam and chemical output of the delivery tool. The operation of the vacuum system 65 may be selected by the operator at the control panel 59 for example, and will operate upon actuation of the trigger 70 of the delivery assembly 55. Alternatively, a separate trigger or other actuation device may be used to selectively apply vacuum when desired.

In one particular configuration, gauges and warning lights are included on the outside of the system at control panel 59 (as shown in FIG. 1), for easy viewing and use by the user. These may include, for example:
a. Steam pressure gauge: when the steam pressure reaches 10 Bar, the machine is ready to be operated. Controls (electronic), that are part of the boiler's design, ensure that the pressure is maintained at approximately 10 Bar.
b. Water level light: when there is no more water or water is low for pumping into the boiler, the heating elements cut off, and a light appears indicating that water need to be replenished.
c. Chemical solution level light: when solution is low, with pump controlled accordingly.
d. Boiler temperature light when the temperature exceeds a predetermined temperature which occurs when the boiler's wall needs to be maintained and the boiler cannot be operated until maintenance is performed. This possible problem can be eliminated in two ways: either filter the water to remove all lime and calcium or use lime removal chemicals in the water feed at intervals.

The system 50 further comprises a chemical pump system. The chemical channel portion 54 of the cleaning assembly 50 must be suitable to deliver more aggressive, environmentally friendly solvents, such as d-limonene, without compromising the interior components of the chemical pump 72. In particular, the interior components are desirably composed of or lined with material resistant to the selected more aggressive solvent. For example, pump made of or lined with polypropylene, and having Viton seals have shown resistant to the solvents d-limonene or the like. One such pump 72, for instance, is the ProMinent (Germany) model BT4a. This pump is made of polypropylene with Viton seals and capable of pumping up to 5 gallons an hour at about 4 Bar (lesser pressure may mean that chemicals may not reach the exit of a long hose).

As shown in FIG. 2, the basic chemical channel 52 includes the chemical pump 72 positioned downstream from the chemical reservoir or storage tank 74. A hose 76 fluidly couples the chemical pump 72 to the handle 56 of the delivery assembly 55.

When a sensor inside the chemical storage tank 74 indicates that the level of chemicals is too low, an indicator device located outside the machine should inform the user that replenishment is necessary. Chemicals can be selectively delivered, (in variable quantities by adjusting the pumping rate), by actuating a button 80 located on the handle 56 of the delivery assembly 55.

As mentioned, the selected solvent chemicals are essential in all applications to ensure the efficiency of the process. Chemicals used will vary depending on the application. However, d-limonene is essential to remove gum and graffiti outdoors, and can be used as a general degreaser but not around or rubber, as around food, and d-limonene has a distinct citrus scent. It is excellent at removing grease stains from sidewalks, and will also attack rubber so as to be ideal at removing tire marks in concrete car parks. Any solvent degreaser can be used to remove gum, but may not be as environmentally friendly as d-limonene.

The delivery hose 85 joining the machine/transport exterior delivery handle 56 should be made of reinforced rubber, for flexibility and strength. Steam and chemicals running through the rubber hose via Teflon hoses. These hoses can be very long, sometimes up to 150 feet.

As shown in FIGS. 5-7, the handle 56 is adapted to receive a plurality of tools/delivery devices for various applications. As seen in these Figs., the telescoping as follows:
a. The handle: The handle 56 receives two channels from the delivery hose 85 which remain separated at the exit 82 and 84. As shown in the cross section of the handle barrel 82 of FIG. 3, the diameter of the steam passage 81 is larger than that of the chemical delivery passage 83. This insures proper alignment between the handle portion 56 and the various delivery tools and lances 57, so that the channels are not accidentally inverted upon assembly. Another channel may be provided for the vacuum system 65 as noted previously.
b. The tool connection: The tool must provide for both the steam and chemical channels. Steam and chemicals run through the tool in one of two ways: either through Teflon hoses running within the tool, or the whole tool is molded with two channels built in. Steam and chemicals do not meet until released on the outside at the end of the tool. Both handle 55/56 and tools must be insulated as the steam is very hot, and the machine operator can burn their hands. The connection or joint between the barrel 82 of the handle portion 56 and the delivery tool 57 is a triple telescopic connection, one for the tool and barrel 56, and one each for the steam and chemical channels. On certain tools, it may be necessary to provide for an additional locking mechanism between the tool and barrel to insure that the tool is not accidentally released from the barrel. As shown in FIGS. 4-6, the male end portion 84 of the handle portion 56 is telescopically inserted into the female end portion 86 of the delivery tool 57. FIG. 4 illustrates than an annular lip 88 of the female end portion 86 circumferentially extends around the male end portion 84.

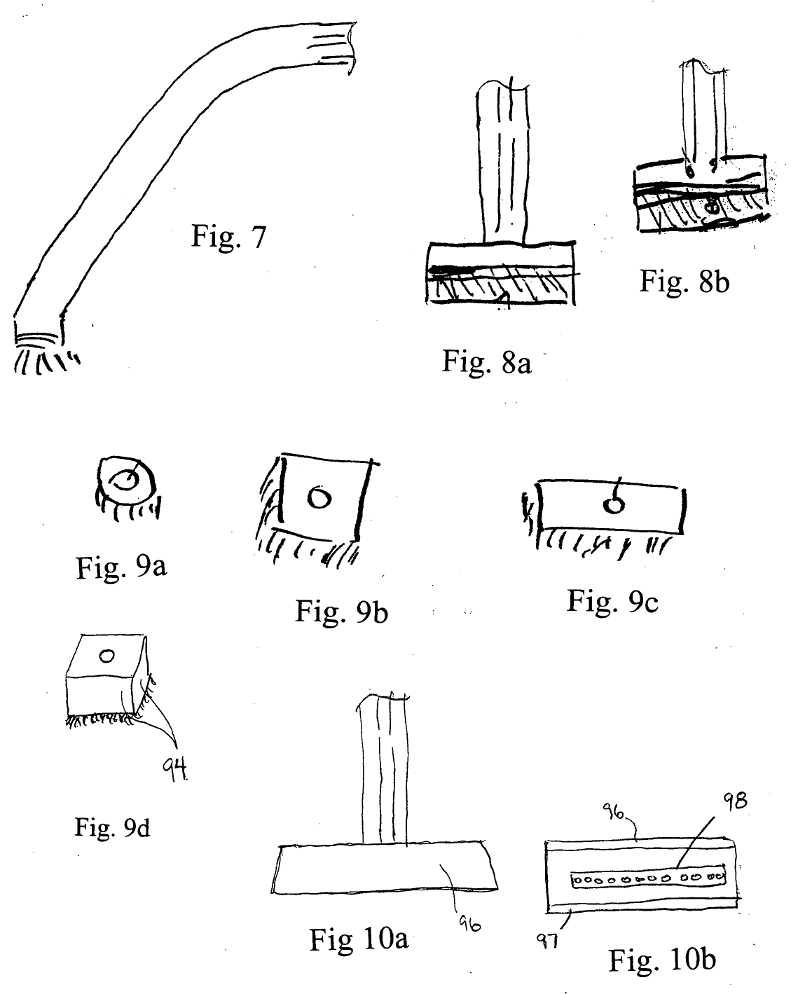

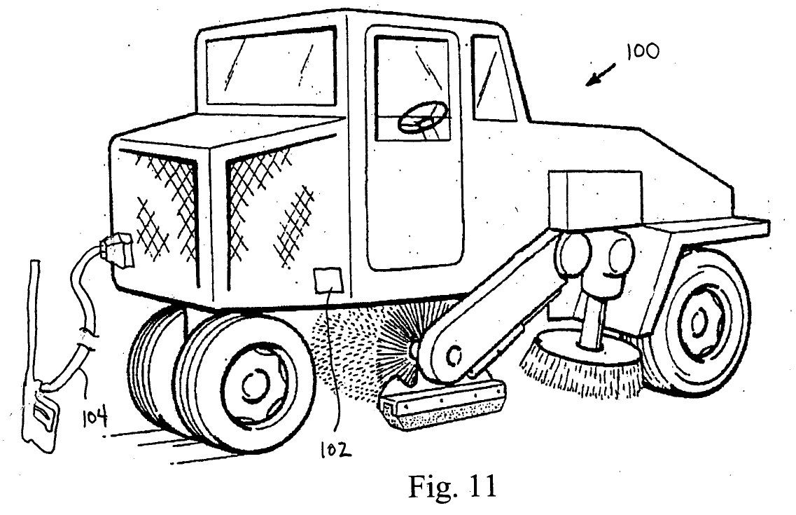

As viewed in FIG. 3, the cross-sectional shape can be rectangular or circular.
c. The Delivery Tools: The following are example delivery tools that can be mated to the handle portion 56 of the delivery assembly 55. In general, due to the low pressure operation of the system, tools other than a nozzle can be used, such a wide brushes as described below, thereby increasing productivity or the applications with which the system may be used.
   i. The long lance: As shown in FIG. 5, this embodiment may have the same cross-sections as FIG. 3, and is typically utilized for cleaning objects of irregular or rounded shape (usually off the floor), such as machines in a factory or plant, conveyor belts or many other objects or surfaces. the length of the telescopic lance portion may be 50-60 cm. for example, or other lengths as desired.
   ii. The short lance: As shown in FIG. 6, this embodiment which may have the same cross-sections as FIG. 3, includes a brush member 90, such as shown in FIG. 9, at a distal end. This device is typically utilized for cleaning objects while scrubbing; examples include graffiti removal and encrusted baking tray or oven cleaning. The short lance may be configured to have an angled elbow shape, with threads to couple the brush 90 thereto. The length of the short lance may be between 15 and 25 cm for example, but other lengths may be used.
   iii. The gum tool: As shown in FIG. 7, this gum removal embodiment which again may have the same cross-sections as FIG. 3 is typically utilized for gum or other stain removal on the ground. It can be fitted with any of the brushes in FIG. 9. the gum tool may have the telescoping connection, and may be angled downwardly to facilitate use with removal of gum on the ground surface, or the surfaces of off the ground objects. For example, the gum tool may have a length of about 120 cm, but other lengths may be used.
   iv. Squeegee tool: As shown in FIG. 8, this squeegee embodiment which may again have the same cross-sections as FIG. 3 is typically utilized to clean and disinfect flat surfaces such as glass or food preparation tables. The squeegee tool may have different widths to facilitate use on different surfaces, such as 25 and 35 cm widths, and may be provided with a rubber portion 92 adjacent the steam and chemical outputs, as shown in FIG. 8B.
d. The brushes: As shown in FIGS. 9A-9C, several brushes can be mounted to the end of the short lance or gum tool. These brushes, as illustrated, can be round as seen in FIG. 9A, square shaped as in FIG. 9B or rectangular as shown in FIG. 9C. Further, the brushes may be enclosed by walls 94, such as shown in FIG. 9D, and may be provided with suction via the vacuum system 65, to allow the cleaned area to be effectively dried by applying a vacuum to the cleaned area.
e. Special Squeegee: As shown in FIGS. 10A and 10B, this squeegee may be mounted on an automatic floor scrubber in lieu of the regular squeegee and may comprise two squeegee members, 96 and 97, separated by a steam dispensing element 98. In this way the floor is first cleaned by the scrubber's brushes then dried by the innermost squeegee. This is followed by disinfecting through the saturated steam which also assists in further drying. The role of the second squeegee is to insure that the steam and therefore heat remains focused on the floor rather than dissipating. Further, this set up insures that cleaning and disinfecting occurs in the correct order. This is designed to be used in fish markets, slaughterhouses and other food processing plants where floor sanitization is essential, as for example, more often than not, in fish markets the fish is placed directly on the floor.

As shown in FIG. 11, the system may be integrated into a mobile platform, such as a vehicle for cleaning in a variety of applications. For example, the system may be integrated into a street cleaning vehicle 100, for use in exterior cleaning applications such as street cleaning, spot cleaning/degreasing, chewing gum removal, graffiti/poster removal, street furniture cleaning, and even weed killing in parks. the vehicle 100 includes a system such as described with respect to prior embodiments incorporated into the vehicle. For such integration, the vehicle 100 is made so that it provides suitable and safe structural support, for the steam machine, power generator, water and chemical solution reservoirs. Also, as an example, the boiler, water/chemical reservoirs, pumps, etc, may be integrated into the vehicle, with a control panel 102 on the exterior for control thereof. A long hose 104 and dispensing system may then be coupled to the outlet ports of the steam and chemical channels of the system for access to objects or surfaces around the vehicle. As the water volumes required for operation are small, the system can be integrated effectively for such applications. It should also be recognized that the cleaning system according to the invention may be integrated into other mobile platforms, such as a floor scrubber, litter pickers, tucks, tractors, utility vehicles, aircraft cleaning systems or the like, allowing the system to be transported to a site for cleaning. An aircraft cleaning vehicle for example, may be a vehicle sized to access the different areas of an aircraft, including the interior for cleaning of chairs, trays, lavatories, carpets and other interior surfaces. Further, the system could be provided in a lift vehicle to clean exterior surfaces of the aircraft. For industrial applications, the system could be integrated into a scrubber or truck type of vehicle, with one or more cleaning systems on board. the system(s) could be used to clean the factory floors and equipment, without any mess or runoff to be concerned with. With use of a vacuum system, the surfaces cleaned in these environments could also be effectively dried.

The foregoing description of embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A steam cleaning system comprising,
a housing,
a steam generating system for producing a low pressure saturated steam, and a steam dispensing system coupled thereto for dispensing said steam from the system to at least one first outlet port;
a cleaning solution dispensing system having at least one reservoir for a cleaning solution, and a pump system for dispensing a predetermined amount of a cleaning solution from said at least one reservoir to at least one second outlet port;
wherein said at least one first and second outlet ports are positioned adjacent one another, such that a mixture of cleaning solution and saturated steam at a low pressure and low volume of steam and cleaning solution is dispensed from the system.

2. The system according to claim 1, wherein said saturated steam is produced at a temperature of 150° C. or above.

3. The system according to claim 1, wherein said saturated steam is produced at a pressure of between 8 to 15 Bar.

4. The system according to claim 1, wherein said steam generating system comprises an induction-type boiler.

5. The system according to claim 4, wherein the steam generating system further comprises at least one water reservoir, a pump and a control system for operating the pump and the boiler.

6. The system according to claim 1, wherein said first and second outlet ports are selectively coupled to an extension member to dispense said mixture to remote locations.

7. The system according to claim 6, wherein said extension member is terminated by a selectively attached dispensing nozzle.

8. The system according to claim 7, wherein said dispensing nozzle is selected from the group consisting of a lance, a ground cleaning wand, a squeegee or a brush.

9. The system according to claim 7, wherein said dispensing nozzle is a lance which is telescopically coupled to a delivery handle.

10. The system according to claim 6, wherein said extension member is a flexible hose having at least two conduits therethrough for delivery of said steam and said cleaning solution to an opposing end thereof.

11. The system according to claim 10, wherein each of said conduits of said delivery hose include a Teflon hose through which said steam and cleaning solution is supplied.

12. The system according to claim 1, wherein the at least one first outlet port is larger than said at least one second outlet port.

13. The system according to claim 12, wherein an extension member is coupled to the first and second outlet ports to dispense said mixture at a remote location, and said extension member has at least first and second conduits corresponding to said first and second outlet ports, to ensure proper coupling of each of said conduits to a respective outlet port.

14. The system according to claim 1, wherein said cleaning solution is D-limonene.

15. The system according to claim 1, wherein said pump system associated with the cleaning solution dispensing system is constructed of materials which are resistant to any cleaning solution.

16. The system according to claim 5, wherein the control system comprises a steam pressure gauge operably coupled to said boiler, a water level indicator operably coupled to said at least one water reservoir and a boiler temperature indicator operably coupled to the boiler for monitoring temperature of steam produced thereby.

17. The system according to claim 16, wherein said control system further comprises at least one warning indicator for indicating operation parameters which are within or outside of predetermined operational parameters associated with the steam generating system.

18. The system according to claim 1, further comprising a vehicle on which said system is mounted for positioning of the cleaning system in any desired location.

19. The system according to claim 1, wherein upon operation, no significant runoff is produced which requires disposal.

20. The system according to claim 5, wherein said at least one water reservoir may be supplied with water without cooling of the boiler.

21. The system according to claim 1, wherein operation of the system only uses between 3 to 10 gallons of water per hour in the production of said low pressure saturated steam.

22. The system according to claim 1, wherein said low pressure saturated steam is heated to approximately 180° C.

23. The system according to claim 1, further comprising a mobile platform with which the system is integrated to allow cleaning to be performed at the location of the mobile platform.

24. The system according to claim 1, wherein the mobile platform is selected from the gorup consisting of a street cleaning vehicle, floor scrubber, litter pickers, trucks, tractors, utility vehicles and aircraft cleaning systems.

25. The system according to claim 1, wherein the mobile platform comprises a power source for supplying power to the system for heating and dispensing steam, and supporting structures for the cleaning system components and power supply.
